(19) United States
(12) Patent Application Publication
(10) Pub. No.: US 2002/0158546 A1
(43) Pub. Date: Oct. 31, 2002

(54) Rotary body and quantum electric motor

(76) Inventor: Isao Nakatani, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 09/979,030

(22) PCT Filed: Mar. 13, 2001
(86) PCT No.: PCT/JP01/01975

(30) Foreign Application Priority Data
Mar. 15, 2000 (JP) 2000-073091

(51) Int. Cl. H02N 1/00

(52) U.S. Cl. 310/300

(57) ABSTRACT

A rotating body in which a number of electrons injected from one rotation surface is the same as a number of electrons ejected from another rotation surface, and in which a degree of spin polarization of electrons injected from one rotation surface is different from a degree of spin polarization of electrons ejected from another rotation surface is used as a rotor, thus making possible a micro motor with a small amount of loss and that has a simple structure.

### TECHNICAL FIELD

The invention of the present application relates to a rotating body and a quantum electric motor. More specifically, the invention of the present application relates to a rotating body that is useful in various types of physical and mechanical equipment, as well as to an electric motor that uses this rotating body as a rotor, and particularly to an electric motor that serves as a rotation drive device for micro equipment.

### BACKGROUND ART

Conventionally, what is called an electric motor is an electromagnetic power device that obtains rotation drive force from the electromagnetic force created when a current is supplied and converts the electromagnetic energy mechanically into energy. For this reason, it is appropriate that this device is called an electromagnetic motor. Electromagnetic motors have a comparatively high level of efficiency and are easy to control in addition to their ease of handling. Provided there is a source of power, they can be readily used anywhere and, not only can they be made from having a large output to having a small size, but they can be made in various configurations having a variety of features. They have a wide range of applications and are used extensively from inside the household to inside the factory.

The operating principle of such electromagnetic motors is based on classic electromagnetic force. Namely, if an electric current is made to flow in a direction at right angles to a magnetic field inside the magnetic field, then based on Fleming's Left Hand Law, forces act in directions at right angles respectively to the direction of the magnetic field and the direction of the current. If the direction of the current is switched in accordance with the sequential rotation such that the relative directional relationship between the magnetic field and the current is kept the same causing the forces to form a rotation force in a constant direction around a central axis, then the rotation is continued in the same direction.

Electromagnetic motors can be roughly divided into direct current motors that use direct current and alternating current motors that use alternating current. The alternating current motors may be further divided into a variety of types such as alternating current commutator motors, synchronous motors, and induction motors each of which has different features and is used in different applications. In addition, a linear motor is a type of alternating current motor that is a prime mover using direct operation instead of rotational operation.

While electromagnetic motors thus have a variety of configurations and a wide range of applications, if an attempt is made to build a micro electromagnetic motor to provide the power for a micro machine, the force that is generated as well as the efficiency are extremely reduced as the size is reduced, resulting in it not being possible to obtain a drive force that can stand up to actual use. This is one of the size effects characteristic of electromagnetics.

The electrostatic motor was provided as compensation for this. An electrostatic motor electrifies a stator and a rotor and changes the electrostatic force (Coulomb force) working between the stator and the rotor into a rotational motion. When the electrostatic motor is large in size, the electrostatic force is extremely weak compared with the electromagnetic force described previously, therefore, it is not possible to generate a large rotation force. However, when the electrostatic motor is small in size, it is possible to generate a large rotation force in proportion to its size compared with an electromagnetic motor. Therefore, electrostatic motors could be considered to be promising replacements for electromagnetic motors as prime movers for micro machines.

However, electrostatic motors have drawbacks such as their need to be supplied with a high voltage in a small space causing difficulties with the insulation. Moreover, they have a complicated structure such as requiring an electronic circuit in which the electrification polarity is changed in alternation to match the rotation in order to obtain the driving.

### DISCLOSURE OF INVENTION

The invention of the present application is proposed in order to solve these problems in conventional micro motors and is intended to provide a rotating body that has a simple structure and that makes the creation of a new micro motor with a small amount of loss possible, and to provide an electric motor that uses this rotating body.

The first aspect of the invention of the present application that is intended to solve the above problems is a rotating body, wherein in a rotating body, a number of electrons injected from one rotation surface is the same as a number of electrons ejected from another rotation surface, while a degree of spin polarization of electrons injected from one rotation surface is different from a degree of spin polarization of electrons ejected from another rotation surface.

In the second aspect of the rotating body of the invention of the present application, the injected electrons and the ejected electrons respectively are electrons that do not have spin polarization and electrons that do have spin polarization, or respectively are electrons that do have spin polarization and electrons that do not have spin polarization. In the third aspect thereof, in the rotating body, one rotation surface is a non-magnetic metal or alloy, while the rotation surface on the other side is a magnetized ferromagnetic metal or alloy, and these two are electrically joined to each other. In the fourth aspect thereof, the magnetized ferromagnetic alloy contains manganese as one of its constituent components. In the fifth aspect thereof, a diameter of the rotating body is 0.01 μm or more and 4 mm or less.

Moreover, in the sixth aspect of the rotating body of the invention of the present application, the rotating body is an axially symmetrical rotating body whose center of gravity is a fulcrum. In the seventh aspect thereof, the rotating body is supported at the fulcrum by a cantilever type bearing. In the eighth aspect thereof, in the axially symmetric rotating body according to the fifth or sixth aspect, an inner cylinder is formed from a non-magnetic metal or alloy, while an outer cylinder that surrounds the inner cylinder is formed from a magnetized ferromagnetic metal or alloy, or an inner cylinder is formed from a magnetized ferromagnetic metal or alloy, while an outer cylinder that surrounds the inner cylinder is formed from a non-magnetic metal or alloy, and both the inner cylinder and the outer cylinder are joined electrically. In the ninth aspect thereof, in the axially symmetric rotating body according to the seventh aspect, current is injected from the cantilever type bearing and is ejected from an outer peripheral surface of the rotating body.

Moreover, the tenth aspect of the invention of the present application is a quantum electric motor that uses the rotating body according to any of the first to ninth aspects as a rotor. In the eleventh aspect thereof, the rotating body is provided inside a gas discharge area and electrons are released inside electrically discharged plasma.

The invention of the present application as it is described above provides micro rotating body that is based on a new principle and a basic structure for an electric motor that uses this micro rotating body. Namely, the micro rotating body and the electric motor that uses this rotating body of the invention of the present application is means for converting the quantum mechanical spin angular momentum of electrons carried by a current into classic mechanical rotation angular momentum of a rotor, and also enables torque and the rotation action of a rotor to be obtained by quantum mechanical action by the inputting of electrical energy. Because this action is a quantum mechanical action, they manifest the characteristic superiority that, particularly when the size of the electric motor is small, there is little loss and a high degree of efficiency relative to electrostatic motors and conventional electromagnetic motors. A quantum electric motor based on the invention of the present application is used as power for a micro machine.

### BRIEF DESCRIPTION OF DRAWINGS

FIG. 1 is a schematic view showing the principle behind the quantum electric motor.

FIG. 2 is a cross sectional view of a Maxwell Spinning Top spin filter rotor.

FIG. 3 is a schematic view showing an embodiment of a quantum electric motor.

Here, reference numerals in the drawings designate as follows:

1. Rotation shaft

2. Non-magnetic disc

3. Magnetic disc

4. Joining surface

5. Fulcrum

6. Magnetic shaft

7. Magnetization vector arrows

8. Electrons

9. Electron flow path

10. Spin polarized electrons

11. Direction of rotation

1A. Tungsten needle

2A. Non-magnetic inner cylinder

3A. Magnetic rotor

12. Rotor fulcrum

13. Non-spin polarized electron flow

14. Current introduction terminal

15. Spin polarized electron flow

16. Maxwell Spinning Top spin filter rotor

17. Glass vacuum container

18. Decompressed inert gas atmosphere

19. Electrical discharge plasma

20. Earth shield

21. Conductance adjustment valve

22. vacuum discharge aperture

23. Inert gas flow adjustment valve

24. Inert gas introduction aperture

25. Earth terminal

### BEST MODE FOR CARRYING OUT THE INVENTION

A detailed description will now be given of the principle of the invention of this application and the rotating body based on this principle as well as of a quantum electric motor that uses this rotating body.

An electron is an elementary particle having a charge e and a spin angular momentum shown below.

πS

The spin angular momentum of the quantum mechanical physical quantity of the electron is the source of the magnetism. At the same time, the fact that the spin angular momentum is equivalent to the angular momentum L of a rigid body in classical mechanics was shown both experimentally and theoretically by A. Einstein and W. J. de Haas in 1915. Prior to that, in the classical mechanics of Neuton, the law of conservation of angular momentum was known; as was the fact that angular momentum is conserved in all mechanical systems including those of celestial bodies. Namely, the fact that, in the law of conservation of angular momentum, the spin angular momentum of electrons in quantum mechanics is also conserved was stressed by Einstein and de Haas, and in the formula below the total angular momentum M is kept constant.

M=L+πS (1)

This effect, which is known as the Einstein-de Haas effect has hitherto been used as physical means for measuring the gyromagnetic ratio of electrons, however, no attempts have yet been made to apply this to the rotational mobility of a prime mover. The reason for this is that when it is applied to mechanical systems normally having a macroscopic size, the torque generated is extraordinarily small and no practical applicability could be expected.

However, the inventors of the present application discovered while researching micro processing technologies that electric motors that use the spin angular momentum of electrons are able to generate a large rotation angular momentum in proportion to their size when their size is small in the extreme such as the size of a micro machine, so that the number of areas where they might be put to practical use are increased. In other words, this is a size effect in a mechanical system. More recently, through the invention of this application, it has become possible for the spin angular momentum of an electron to be applied to mechanics systems extending, in magnetic physics, as far as the electron spin filter effect being discovered at the joining surface of a semiconductor and a magnetic body or of a non-magnetic body and a magnetic body. The invention of this application was formed from the above background.

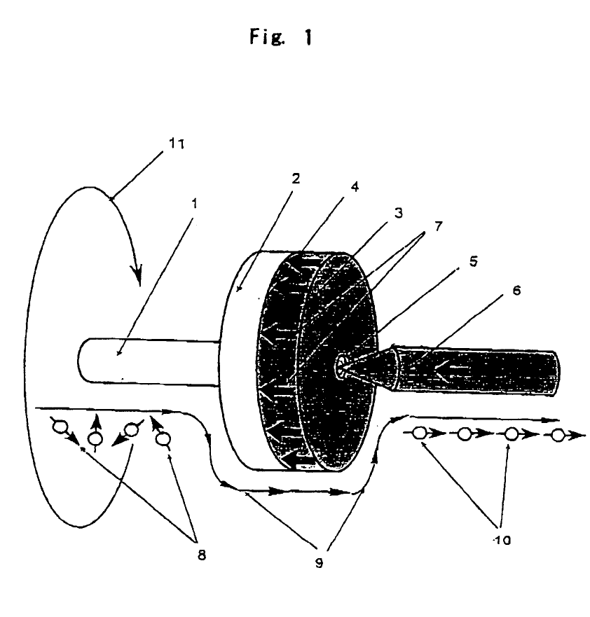

Firstly, a description will be given based on the typical view shown in FIG. 1 of the principle of the quantum electric motor of the invention of the present application. A disc (2) made from a non-magnetic material such as copper or gold is joined mechanically as well as electrically at a joining surface (4) with a magnetized ferromagnetic metal or alloy magnetic disc (3). Moreover, a rotation shaft (1) formed from the same non-magnetic material is joined mechanically and electrically to the non-magnetic disc (2), while the magnetic disc (3) is supported at a fulcrum (5) by a shaft (6) made from the same type of magnetic material and magnetized in the same direction. Both are joined electrically while being able to move in a sliding manner. The directions or the magnetizations are shown by the arrows (7). The magnetized ferromagnetic metal or alloy magnetic disc (3) and shaft (6) are made from a ferromagnetic metal such as iron, nickel, or cobalt, or from a ferromagnetic alloy that includes these in its composition and these may maintain a magnetic state in which the magnetic field is continuously applied from the exterior, or pre-magnetized conductive permanent magnetic alloys such as alnico alloy, ESD magnet alloy, Mn—Al alloy, Sm—Co alloy, Md—Fe—B alloy or the like may be used. In a system such as this, a direct current is made to flow in the direction from the side of the magnetic shaft (6) to the non-magnetic rotation shaft (1). As a result, the free electrons (8) serving as charge carriers flow in from the side of the non-magnetic rotation shaft (1) along the path (9) shown in the drawing, pass along the non-magnetic disc (2), the joining surface (4), and the magnetic disc (3) respectively, and exit at the magnetic shaft (6) side. At this time, the direction of the spin of the electrons (8) flowing in from the non-magnetic rotation shaft (1) is scattered irregularly as is shown in typical view by the directions of the arrows. Electrons such as these are called non-polarized electrons. When the non-polarized electrons (8) pass through the joining surface (4) between the non-magnetic disc (2) and the magnetic disc (3), the direction of the spin thereof is converted into the opposite direction to the direction (7) of the magnetization of the magnetic body, and the electrons (8) leave the system from the magnetic shaft (6) with the directions of the spin of each electron aligned. Electrons such as these are called spin polarized electrons (10). At this time, not all of the electrons are polarized, but only a fixed proportion of the electrons are polarized. The proportion of polarized electrons is called the spin polarization degree P and is defined by the following formula.

P=(n⁺−n⁻)/N (2)

n⁺>n⁻ (3)

Here, N is the total number of electrons, n⁻ is the number of electrons having a spin in the direction opposite to the magnetization, and n⁻ is the number of electrons having a spin in the same direction as the magnetization.

P has a set value for each magnetic body, for example, approximately 0.4 for iron, 0.3 for nickel, and approximately 1.0 for manganese alloy. Namely, polarized electrons are present in a ratio of 7:3 for iron and occupy all the electrons for a manganese alloy.

The result of this is that an unbalanced portion is generated in the spin angular momentum in the electron spin system and, in a rotation system that is supported so as to be able to rotate freely, in order to keep the total angular momentum M constant using Formula (1) above, the mechanical angular momentum L takes a finite value so as to nullify the unbalanced portion, and the rotation system obtains a rotation drive force in the direction shown by the arrow (11).

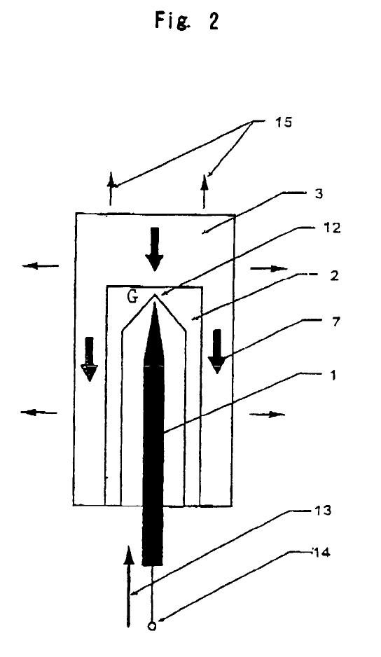

FIG. 2 is a cross sectional view of a rotor used as an example of a structure for rationally achieving the above principle. The rotor is formed by hollowing out the inside of a magnetic rotor (3A) formed, for example, from a Mn—Al alloy magnet that is magnetized in the direction of the arrows (7) and inserting inside this a non-magnetic inner cylinder (2A) made from copper, for example. The boundary faces of these two forma joint between a non-magnetic body and a magnetic body. The interior of the copper non-magnetic inner cylinder (2A) is hollowed out in a cone shape such chat the apex thereof forms the center of gravity G of the whole rotor and is supported by a sharp, for example, tungsten needle (1A). This forms the fulcrum (12) for the rotor at the same time as forming the contact point for the current. Rotors in which the fulcrum coincides with the center of gravity have been known for a long time as Maxwell Spinning Tops. In the invention of the present application, by forming the rotor with a Maxwell Spinning Top structure, stable, high-speed rotation is made possible by a cantilever type bearing. On the other hand, the electrons are introduced from a current introduction terminal (14) connected to the tungsten needle (1A); pass through the tungsten needle (1A), the fulcrum (12), the non-magnetic inner cylinder (2A), and the magnetic rotor (3A) and are carried out as indicated by the arrows (15) from the surface of the magnetic rotor (3A) into a plasma atmosphere that is described below.

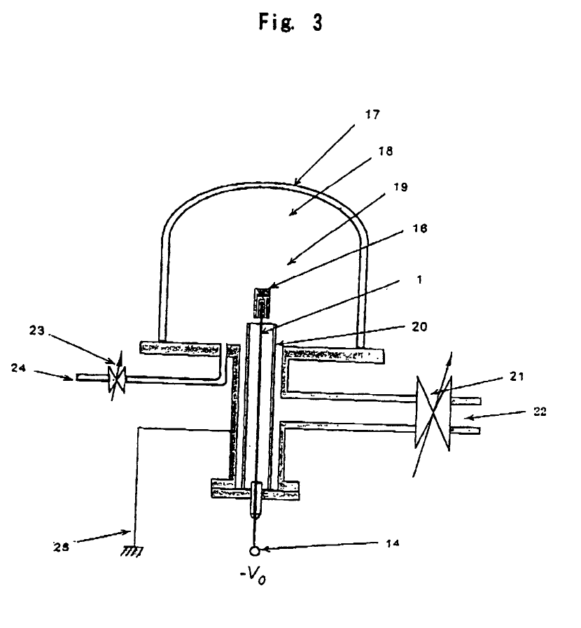

FIG. 3 is a schematic view showing an embodiment of a quantum electric motor equipped with a Maxwell Spinning Top rotor. The Maxwell Spinning Top rotor (16) and the tungsten needle (1A) supporting it are installed in a vacuum container (17) and are electrically connected to a current introduction terminal (14) via an insulated vacuum flange. The vacuum container (17) expels air from a vacuum exhaust pipe (22) into a vacuum while adjusting the rate of expulsion using a vacuum valve (21), and at the same time introduces argon gas, for example, from a gas introduction pipe (24) into a vacuum while adjusting the flow rate using a flow rate adjustment valve (23) so that the pressure of the argon gas inside the vacuum container (17) is adjusted to the range of 0.1 to 100 Pa. The entire vacuum container (17) is earthed k by an earth terminal (25) so that a zero potential is maintained. In this structure, if a negative voltage −v₀ is applied to the Current introduction terminal (14), argon gas plasma (19) is generated around the rotor (16). Note that V₀ is suitably between 100 and 1000 V. Note also that an earth shield (20) surrounds the tungsten needle (1A) and is a circular cylinder made from metal held at the same potential as the vacuum container. The earth shield (20) has the role of limiting the generation of plasma to only the area around the rotor (16).

Examples will now be given to describe the present invention in even more detail.

Naturally, the invention of the present application is not limited by the examples described above. It is possible for the specific configuration of the present invention to have even more varied forms.

### EXAMPLES

A Maxwell spinning Top spin filter rotor was constructed as is shown in FIG. 2. Namely, a hole having a depth of 1.25 mm and a diameter of 0.5 mm is provided in a magnetic rotor (3A) formed from a Mn—Al magnet alloy (with a density of 5.5 g/cc) having a length of 1.5 mm and a diameter of 1.0 mm. A non-magnetic inner cylinder (2A) made from high purity electrolytic copper and having a diameter of 0.5 mm and a length of 1.25 mm is then inserted exactly inside the hole and fixed. Note that a hole having a diameter of 0.38 mm and a depth of 0.98 mm and having a conical end point with an apex angle of 90° is formed along the central axis of the electrolytic copper non-magnetic inner cylinder (2A). The dimensions of this hole are set such that the fulcrum (12) serving as the conical apex of the end point of the hole forms the center of gravity G of the rotor (3A) as a whole. Note also that the manufacturing of these elements is performed by electrical discharge machining and precision grinding. After the spin filter rotor has been assembled, it is interposed between facing electrodes of an electromagnet and a 2MA/m magnetic field is applied so as to create magnetism in the direction shown by the arrows (7) of the magnetized vector. A gold plated tungsten needle (1A) having a diameter of 200 pm and whose distal end is precision ground to a sharp point by electrolytic precision grinding is used in the spin non-polarized electron emitter rotation bearing.

The overall quantum electric motor has the structure shown in FIG. 3. Namely, the spin filter rotor (16) is installed inside a small sized vacuum container (17) having a glass bell jar with an internal diameter of 50 mm and argon gas is introduced into the interior of the vacuum container by the above described method, with the air being expelled using a vacuum pump so that the pressure is adjusted to approximately 10 Pa. The whole vacuum container is grounded and a voltage of −220 v is applied to the current introduction terminal (14). As a result of this, pale reddish purple argon gas plasma (19) is generated inside the vacuum container, a 2 mA current flows, and the rotor begins to rotate. The argon gas plasma is particularly affected by the magnetic line of force generated from the magnetized spin filter rotor and has a high density in the central portion of the rotor so that a wheel of pale reddish purple light is generated in the center of the rotor. The rotation of the rotor can be easily visualized via the action of the wheel of light. The rotation continues for several seconds while accelerating to reach a speed of approximately 20 rpm.

### INDUSTRIAL APPLICABILITY

As has been described above in detail, as a result of the invention of this application, it also becomes possible to construct a micro motor with a small amount of loss and that has a simple structure. A rotating body and an electric motor that uses this rotating body are provided that achieve a quantum mechanical action.

1. A rotating body, wherein
in the rotating body, a number of electrons injected from one rotation surface is the same as a number of electrons ejected from another rotation surface, while a degree of spin polarization of electrons injected from one rotation surface is different from a degree of spin polarization of electrons ejected from another rotation surface.

2. A rotating body, wherein
the injected electrons and the ejected electrons respectively are electrons that do not have spin polarization and electrons that do have spin polarization, or respectively are electrons that do have spin polarization and electrons that do not have spin polarization.

3. The rotating body according to claim 1 or 2, wherein in the rotating body, one rotation surface is a non-magnetic metal or alloy, while the rotation surface on the other side is a magnetized ferromagnetic metal or alloy, and these two are electrically joined to each other.

4. The rotating body according to claim 3, wherein the magnetized ferromagnetic alloy contains manganese as one of its constituent components.

5. The rotating body according to any one of claims 1 to 4, a diameter of the rotating body is 0.01 μm or more and 4 mm or less.

6. The rotating body according to any one of claims 1 to 5, wherein the rotating body is an axially symmetrical rotating body whose center of gravity is a fulcrum.

7. The rotating body according to claim 6, wherein the rotating body is supported at the fulcrum by a cantilever type bearing.

8. A rotating body, wherein in the axially symmetric rotating body according to claim 5 or 6, an inner cylinder is formed from a non-magnetic metal or alloy, while an outer cylinder that surrounds the inner cylinder is formed from a magnetized ferromagnetic metal or alloy, or an inner cylinder is formed from a magnetized ferromagnetic metal or alloy, while an outer cylinder that surrounds the inner cylinder is formed from a non-magnetic metal or alloy, and both the inner cylinder and the outer cylinder are joined electrically.

9. A rotating body, wherein in the axially symmetric rotating body according to claim 7, current is injected from the cantilever type bearing and is ejected from an outer peripheral surface of the rotating body.

10. A quantum electric motor that uses the rotating body according to any one of claims 1 to 9 as a rotor.

11. A quantum electric motor that uses the rotating body according to claim 9 as a rotor, wherein the rotating body is provided inside a gas discharge area and electrons are released inside electrically discharged plasma.
